(19) United States
(12) Patent Application Publication
(10) Pub. No.: US 2017/0001895 A1
(43) Pub. Date: Jan. 5, 2017

(54) TREATMENT OF WASTEWATER EFFLUENT FROM PULP AND PAPER MANUFACURING

(71) Applicants: Abbas Hasannattaj Jelodar, Mazandaran (IR); Masoumeh Mohammadi Ledari, Mazandaran (IR)

(72) Inventors: Abbas Hasannattaj Jelodar, Mazandaran (IR); Masoumeh Mohammadi Ledari, Mazandaran (IR)

(21) Appl. No.: 15/265,185

(22) Filed: Sep. 14, 2016

(51) Int. Cl. C02F 9/00; C02F 1/72; C02F 1/44; C02F 1/74; B01D 65/02; B01D 71/68; C02F 1/52; B01D 61/14

(52) U.S. Cl. CPC C02F 9/00; C02F 1/52; C02F 1/722; B01D 61/142; C02F 1/725; C02F 1/74; B01D 65/02; B01D 71/68; C02F 1/444; C02F 2101/30

(57) ABSTRACT

A system and method for treatment of wastewater produced in pulp and papermaking processes, for TSS removal and COD decreasing to a de-colored, near neutral pH, liquid effluent, is disclosed. The system and method utilizes a series of tanks which can hold the wastewater and mix the wastewater or bring it in contact with various agents and membranes with an in-line continuous process.

### TECHNICAL FIELD

The present disclosure relates generally to the treatment of waste water and more especially, waste effluent from the manufacture of pulp and paper, known as pulp mill effluents.

### BACKGROUND

As is well known, large volumes of water are used in the manufacture of bleached kraft pulp. After using and possibly reusing the water in various processing steps, the effluent produced invariably contains various deleterious substances dissolved in the effluents, such as, for example, toxic and colored compounds and chemicals that have significant biological oxygen demand (BOD). Toxicity, color and BOD are not necessarily mutually exclusive properties of deleterious substances. In addition to the above, significant quantities of suspended solids in forms of pulp fibers, bark fines, etc. may be present. Toxic substances may be derived from the pulping process as well as from the bleaching and the sheet-forming processes. The nature of these toxic substances may be wood extractives, such as, for example, resin acids, lignin degradation products, such as, for example, guaiacol and catechol and other phenolic compounds or chlorinated lignin degradation products including chlorinated phenols. When these waste waters are discharged directly into receiving waters, they may cause acute as well as chronic toxicity to fish and other aquatic life. Colored substances may be chromophoric compounds derived from both the pulping and bleaching processes. It is known that highly-colored effluent may damage the ecological balance of receiving waters as the penetration of sunlight necessary for photosynthesis of phytoplankton's is severely reduced. The problem of discharging these effluents into receiving waters is becoming increasingly acute as new regulations are promulgated by federal, state and local governments limiting such discharges.

In most commercial systems, chemical clarification and filtration are utilized in an attempt to achieve suspended and colloidal solids removal. The sewage is first subjected to a preliminary treatment. Then a coagulant is added and the sewage sent to a clarification tank. The sludge is removed and an optional filtration step may be used to enhance sludge removal and to provide clarified sewage. The clarified sewage is then sent to a carbon adsorption zone. An optical filtration step is then carried out. A large number of coagulants and polyelectrolytes have been disclosed as being useful including organic polymers (e.g. polyacrylamides), iron salts, aluminum salts, and lime. The role of the activated carbon adsorption step is the removal of soluble organics from the waste water. The total organic removal achieved by the combination of clarification and carbon adsorption is quite high (95%+) and the residual organics after treatment are quite low. In the past, the waste water accumulating from pulp production were frequently boiled down and the residues subsequently burned. Disregarding the high energy cost accruing with the boiling-down, large amounts of halogen are released from the bleaching waste waters with burning of the residues, which may lead to extensive pollution of the environment, and therefore may be very unsatisfactory.

The processes used up to the present time for purification or elimination of the large volumes of waste water accumulating from pulp production are mostly rather time-consuming, intermittent and costly and still may not provide the desired satisfactory results in terms of waste waters which pollute the environment as little as possible.

Waste water effluent has been treated by first acidifying the effluent to a pH below 5 and then scrubbing resultant released gases with an alkaline medium having a of above 12. Kraft pulp-mill effluent treatment has been described as including three stages, one of the stages involving passing spent cooking liquor through a filter bed containing a humic acid-type coal material.

Other solutions of the waste water problems which arise have been suggested, e.g. super-filtration or adsorption methods. However, it has been shown that these known methods are generally not suitable for continuous purification to the required degree of the waste water charged with a large load of dirt, so that it can without hesitation be fed back into the water system. It has particularly been shown that the waste waters which are so pre-treated cannot be fed into a biological purification, since they still contain chemicals from the bleaching which damage the microorganisms in a biologically activated sludge installation, and thus would greatly impair the process. That is why such processes have not been used extensively in the pulp, paper and cardboard industries.

### SUMMARY

Accordingly, it is an object of some implementations of the present application to provide a system and method for treatment of wastewater effluent produced in papermaking process. In some implementations, the wastewater effluent may be processed continuously through an in-line multi-tank system. In some implemantaitons the resulting treated effluent may be recycled back into a papermaking process. In some implementations the process may be performed without addition of conventional chemical compounds such as coagulants.

In some aspect of some implementations, a system and method for treatment of wastewater effluent produced in papermaking processes, for TSS removal and COD decreasing to a de-colored, near neutral pH, liquid effluent, is described. The system and method utilizes a series of tanks which can hold the wastewater and mix the wastewater or bring it in contact with various agents and membranes with an in-line continuous process The resulting treated effluent may be recycled to the pulp and paper making process and be reused.

Disclosed aspects include a system and method for treatment of reuse wastewater produced in papermaking processes, to a de-colored, near neutral pH, liquid effluent. The system and method comprises a series of devices and steps which can hold the waste water and mix the wastewater or bring it in contact with various agents and membranes with an in-line continuous process.

The present application, in some implementations, provides a system and process for purification of wastewaters accumulating from pulp, paper recycling and cardboard industries in which the aforementioned drawbacks are entirely or for the most part overcome, wherein, particularly in reference to environmental pollution, particularly problematical components and chemicals are eliminated in a technically and economically satisfactory manner.

A disclosed system and method of treatment of pulp and paper mill effluent can include five stages. In an aspect, the first stage can include rapid mixing of the wastewater for coagulation. The coagulant agents injected in this stage are harmless and biocompatible. The second stage can include slow mixing for further flocculation (flocculator). Since the coagulant aids are proven to be biologically harmful, the use of coagulant aids is eliminated in this process. The third stage can include passing the effluent through a hydraulically-driven membrane. The fourth stage can include advanced oxidation treatment/catalytic treatment. The fifth stage can include ultra-filtration of the effluent.

In an aspect, the coagulation agents may not include one or more of ferric chloride, sodium aluminate, aluminum sulfate and aluminum chloride.

The rapid mixing stage includes a stainless steel tank. The hydraulic retention time (HRT) is approximately 60 seconds. The effluent leaves the tank through a valve, which is shut on and off manually.

The coagulants are stored in a storage tank and being injected to the rapid mixing tank via an injection pump. The rapid mixing tank includes a variable-speed propeller. In a preferred application, the rotation speed is set to 200 RPM. An electromotor provides the power for mixing the materials inside the rapid mixing tank. The rapid mixing process is facilitated by baffles installed vertically on the interior wall of the mixing tank. The baffles are designed to make turbulence which improves the mixing process. A manual safety valve is installed at the bottom of the rapid mixing tank for emergency drainage.

The third stage for treatment of pulp and paper effluent system includes a hydraulically-driven membrane system for wastewater filtration. The membranes are a polyester-steel-polysolophon micro-membrane (MF) followed by a polysolophon ultra-membrane (UF). A hydraulic cylinder pipe installed inside the membrane tank drives the effluent through the membranes. The hydraulic cylinder pipe also can provide backwashing the membranes by the applying of a vacuum (negative pressure) in the reverse flow direction, which furthermore results in minimizing fouling of the membranes by clearing collections of matter that may accumulate on the front side of the membranes. The hydraulic cylinder pipe may also enable the membranes to work continuously. Such continuous operation, when implemented, provides an example of one of the many advantages of some implementations of this disclosure over most commercial systems. The speed of the hydraulic cylinder pipe is controlled by 2 control valves through 2 high pressure (250 bar) tubes. The effluent and influent flow rates and their ratio is measured by a sensor. There are 2 collectors to collect effluent from the membranes which may be used for further backwashing via a 10 bar back air. The variable time is 6 seconds and the tube is 2 cm in diameter. The membrane system may be controlled by a PLC system.

The present application uses hydrogen peroxide (H₂O₂) as the oxidizer and zinc oxide (ZnO) as the catalyst in the fourth stage. The zinc oxide catalyst is installed on the interior wall of the advanced oxidation tank. Hydrogen peroxide is injected to the tank at 12-20 mg/l rate. The effluent from fourth stage then enters the fifth stage for final purification. It should be noted that, the final sludge may be recycled and reused for the pulp and paper making process.

### BRIEF DESCRIPTION OF THE DRAWINGS

Features of the subject technology are set forth in the appended claims. However, for purpose of explanation, several implementations of the subject technology are set forth in the following figure.

FIG. 1 illustrates a schematic diagram of the treatment of paper recycling wastewater plant, according to a preferred implementation of the instant application.

### DETAILED DESCRIPTION

In the following detailed description, various examples are presented to provide a thorough understanding of inventive concepts, and various aspects thereof that are set forth by this disclosure. However, upon reading the present disclosure, it may become apparent to persons of skill that various inventive concepts and aspects thereof may be practiced without one or more details shown in the examples. In other instances, well known procedures, operations and materials have been described at a relatively high-level, without detail, to avoid unnecessarily obscuring description of inventive concepts and aspects thereof.

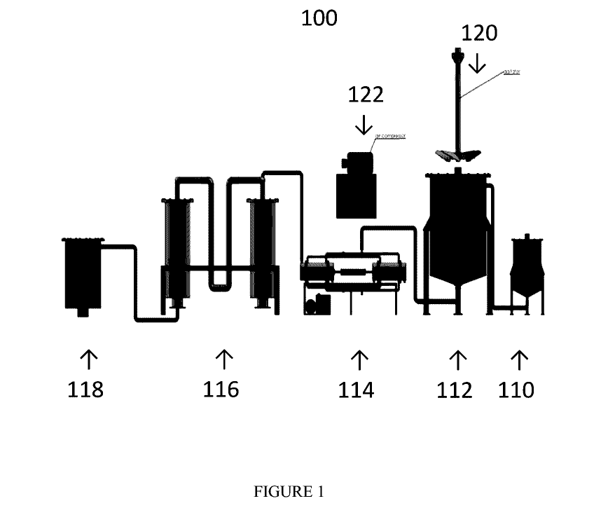

FIG. 1 depicts the treatment of paper recycling wastewater treatment plant according to a preferred implementation of the present application. The system and process for treatment of pulp and paper effluent 100 consists of five consecutive stages which occurs in five consecutive tanks: In the first stage 110, the effluent leaving the papermaking process enters a rapid mixing tank for rapid mixing for coagulation. Coagulants are added to facilitate the coagulation process. In the second stage 112, effullent leaving the first stage 110 enters a slow mixing tank for flocculation wherein, in some implementations, no additional flocculation aid is added. The second stage 112 provides extended time for the coagulation process to proceed. In the third stage 114, effluent leaving the second stage 112 enters a membrane tank which includes a membrane for wastewater filtration. In the fourth stage 116 effluent from the third stage 114 then enters an oxidation tank for organic material removal in the fourth stage 118. In the fifth stage 118, effluent leaving the fourth stage 116 enters a purification tank for final purification.

The first stage 110 will now be described. The first stage includes a rapid mixing tank. Rapid or Flash mixing is the process by which a coagulant agent is rapidly and uniformly dispersed through the mass of water. This process usually occurs in a small basin immediately preceding or at the head of the coagulation basin. Generally, the detention period is 30 to 60 seconds and the head loss is 20 to 60 cms of water. Here colloids are destabilized and the nucleus for the floc is formed. Slow mixing brings the contacts between the finely divided destabilized matter formed during rapid mixing. The flocculation process can be broadly classified into two types, perikinetic and orthokinetic. Perikinetic flocculation refers to flocculation (contact or collisions of colloidal particles) due to Brownian motion of colloidal particles. The random motion of colloidal particles results from their rapid and random bombardment by the molecules of the fluid. Orthokinetic flocculation refers to contacts or collisions of colloidal particles resulting from bulk fluid motion, such as stirring. In systems of stirring, the velocity of the fluid varies both spatially (from point to point) and temporally (from time to time). The spatial changes in velocity are identified by a velocity gradient, G. G is estimated as G=(P/hV)^{1/2}, where P=Power, V=channel volume, and h=absolute viscosity. The mechanisms of flocculation are divided into two groups. 1—Gravitational flocculation: Baffle type mixing basins are examples of gravitational flocculation. Water flows by gravity and baffles are provided in the basins which induce the required velocity gradients for achieving floc formation. And 2—Mechanical flocculation: Mechanical flocculators consists of revolving paddles with horizontal or vertical shafts or paddles suspended from horizontal oscillating beams, moving up and down. Present application uses both methods to enhance the flocculation process.

The first stage 110 utilizes a stainless steel rapid nixing tank which is 125 cm in height and 80 cm in diameter. The hydraulic retention time (HRT) is approximately 60 seconds for 150 cubic meter of wastewater per day. The effluent leaves the rapid mixing tank through a 10 cm in diameter polyethylene tube, which is shut on and off manually.

Salts of Al(III) and Fe(III) are commonly used as coagulant agents in water and wastewater treatment. When a salt of Al(III) and Fe(III) is added to water, it dissociates to yield trivalent ions, which hydrate to form aqua-metal complexes Al(H₂O)₆³⁺ and Fe(H₂O)₆³⁺. These complexes then pass through a series of hydrolytic reactions in which H₂O molecules in the hydration shell are replaced by OH⁻ ions to form a variety of soluble species such as Al(OH)²⁺ and Al(OH)²⁺. These products are quite effective as coagulants as they adsorb very strongly onto the surface of most negative colloids.

Al(III) and Fe(III) accomplish destabilization by two mechanisms: (1) Adsorption and charge neutralization and (2) Enmeshment in a sweep floc.

In an aspect, the coagulation agents can include ferric chloride, sodium aluminate, aluminum sulfate and aluminum chloride. In other aspects, any one or more or all of these coagulation agents may be eliminated.

Interrelations between pH, coagulant dosage, and colloid concentration determine mechanism responsible for coagulation. Charge on hydrolysis products and precipitation of metal hydroxides are both controlled by pH. The hydrolysis products possess a positive charge at pH values below iso-electric point of the metal hydroxide. Negatively charged species which predominate above iso-electric point, are ineffective for the destabilization of negatively charged colloids. Precipitation of amorphous metal hydroxide is necessary for sweep-floc coagulation.

The solubility of Al(OH)₃(s) and Fe(OH)₃(s) is minimal at a particular pH and increases as the pH increases or decreases from that value. Thus, pH must be controlled to establish optimum conditions for coagulation. Alum and Ferric Chloride reacts with natural alkalinity in water as follows:

Al₂(SO₄)₃.14H₂O+6 HCO³⁻→2 Al(OH)₃(s)+6CO₂+14 H₂O+3 SO₄²⁻ (1)

FeCl₃+3 HCO³⁻→Fe(OH)₃(S)+3 CO₂+3 Cl⁻ (2)

The coagulants are stored in a 1000-liter storage tank and being injected to the mixing tank via an injection pump. The rapid mixing tank includes a variable-speed propeller 100 cm in length. In a preferred application, the rotation speed is set to 200 RPM. A 4 kW electromotor provides the power for mixing the materials inside the rapid mixing tank. The rapid mixing process is facilitated by 3 baffles installed vertically on the interior wall of the mixing tank. The 120*40 cm² baffles are designed to make turbulence which improves the mixing process. A manual 10 cm in diameter safety valve is installed at the bottom of the tank for emergency draining.

Flocculation is stimulation by mechanical means to agglomerate destabilized particles into compact, fast settleable particles (or flocs). Flocculation or slow mixing results from velocity differences or gradients in the coagulated wastewater, which causes the fine moving, destabilized particles to come into contact and become large, readily settleable flocs. An initial rapid mixing step is provided for the dispersal of the coagulant or other chemicals into the water prior to slow mixing

The second stage 112 will not be described. The second stage includes a slow mixing tank. Slow mixing is done in this stage, during which flocculation, ie., the growth of the floc takes place.

The second stage 112, includes a 300 cm-long 130 cm-high stainless steel tank. The effluent exiting from the first stage 110 remains slowly-stirred in the second stage 112 for approximately 30 min. The effluent is stirred by 4 propellers 120 at 25-30 RPM. Afterwards, the effluent leaves the tank through a 7.5 cm polyethylene tube. A floater which floats inside the second stage tank 112. controls the wastewater level.

In some implementations the rapid mixing tank 110 and the slow mixing tank 112 can be implemented as one tank having two impeller speeds. In such implementations the first and second stages can be performed in order in a common tank.

The third stage 114 will now be described. The third stage includes a membrane tank. There are two types of membrane filtration technology for water and wastewater treatment, namely ultrafiltration (UF) and microfiltration (MF). UF has pores of 0.01-0.02 μm, while ME for water treatment has pores of 0.04-1 μm. In wastewater applications, coarser MF pore sizes of 0.2 and 0.4 μm can be used, but the finer MF membranes for water treatment duties are also suitable. MF removes common particles found in water including bacteria and other microbial organisms, while UF removes viruses in addition, thereby providing a physical disinfection barrier.

The third stage 114 for treatment of pulp and paper effluent includes a hydraulically-driven membrane system for wastewater filtration. The membranes are a polyester-steel-polysolophon micro-membrane (MF) followed by a polysolophon ultra-membrane (UF). A hydraulic cylinder pipe installed inside the membrane tank drives the effluent through the membranes. The hydraulic cylinder pipe also provides backwashing of the membranes which is furthermore results in minimizing the fouling the membranes. The hydraulic cylinder pipe may also enable the membranes to work continuously as opposed to the most commercial systems. The speed of the hydraulic cylinder pipe is controlled by 2 control valves through 2 high pressure (250 bar) tubes. The effluent and influent flow rates and their ratio is measured by a sensor. There are 2 collectors to collect effluent from the membranes which may be used for further backwashing via a 10 bar back air. The variable time is 6 seconds and the tube is 2 cm in diameter. The membrane system may be controlled by a PLC system.

The fourth stage 116 will now be described. The fourth stage includes an oxidation tank. In the fourth stage, a catalytic oxidation process is capable of converting organic contaminants ultimately to carbon dioxide and water, and can also remove oxidizable inorganic components such as cyanides and ammonia. While the process usually uses air as the oxidant, which is mixed with the effluent and passed over a catalyst at elevated temperatures and pressures, the present application uses hydrogen peroxide (H₂O₂) as the oxidizer and zinc oxide (ZnO) as the catalyst. The zinc oxide catalyst is installed on the interior wall of the advanced oxidation tank. Hydrogen peroxide is injected to the tank at 12-20 mg/l rate.

The fifth stage 118 will now be described. The fifth stage includes a purification tank. The effluent from the fourth stage 116 enters the fifth stage 118 for final purification. It should be noted that, the final sludge from any or all stages may be recycled and reused for the pulp and paper making process.

An air compresser 122 is provided in some implementations to provide pressure to move the effulent between tanks, back pressure for backwashing of the membrane, and/or to provide air for oxidation in the fourth stage.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A system for treatment for pulp and paper recycling wastewater treatment comprising:
a first stage that receives wastewater leaving a papermaking process so that an effluent enters a rapid mixing tank for rapid mixing for coagulation, wherein coagulants are added to the effluent for coagulation of the effluent ;
a second stage that receives the effluent from the first stage so that the effluent enters a slow mixing tank for flocculation of the effluent;
a third stage that receives the effluent from the second stage so that the effluent enters a membrane tank having at least one membrane for filtration of the effluent;
a fourth stage that receives the effluent from the their stage so that the effluent enters an oxidation tank for oxidation of the effluent, wherein the oxidation tank includes an oxidizer and a catalyst for at least partial removal of organic compounds and colors; and
a fifth stage that receives the effluent from the fourth stage so that the effluent enters a purification tank for purification of the effluent.

2. The system of claim 1, wherein the hydraulic retention time is approximately 60 seconds in the rapid mixing tank and approximately 30 minutes in the slow mixing tank.

3. The system of claim 1, wherein the effluent is stirred approximately at 200 RPM in the rapid mixing tank and approximately at 25-30 RPM in the slow mixing tank.

4. The system of claim 1, wherein the third stage membrane includes a micro-membrane and an ultra-membrane.

5. The system of claim 4, wherein micro-membrane further comprises a steel-solophone-polyester membrane and the ultra-membrane further comprises a colophone membrane.

6. The system of claim 1, wherein the second stage does not include adding of coagulants.

7. The system of claim 1, wherein the coagulants do not include at least one of ferric chloride, sodium aluminate, aluminum sulfate and aluminum chloride.

8. The system of claim 1, wherein the coagulants do not include any of ferric chloride, sodium aluminate, aluminum sulfate and aluminum chloride.

9. The system of claim 1, wherein the membrane tank includes a hydraulic cylinder pipe.

10. The system of claim 9, wherein the hydraulic cylinder pipe performs backwashing of the membranes.

11. A method of treatment of pulp and paper recycling wastewater, the method comprising steps of;
coagulating an effluent, by adding coagulants to the effluent in a rapid mixing tank;
subsequent to the step of coagulating, flocculating the effluent, in a slow mixing tank;
subsequent to the step of flocculating, filtering the effluent, by passing the effluent through a membrane tank having a micro-membrane and an ultra-membrane;
subsequent to the step of filtering, oxidizing the effluent, by passing the effluent through an oxidation tank containing a catalyst and adding an oxidizing agent; and
subsequent to the step of oxidizing, purifying the effluent, by passing the effluent through a purification tank.

12. The method of claim 11, wherein the coagulants do not include at least one of ferric chloride, sodium aluminate, aluminum sulfate and aluminum chloride.

13. The method of claim 11, wherein the hydraulic retention time is approximately 60 seconds in the rapid mixing tank and approximately 30 minutes in the slow mixing tank.

14. The method of claim 11, wherein the effluent is stirred approximately at 200 RPM in the rapid mixing tank and approximately at 25-30 RPM in the slow mixing tank.

15. The method of claim 11, wherein the membrane tank includes a micro-membrane and an ultra-membrane, wherein the micro-membrane further comprises a steel-colophone-polyester membrane and the ultra-membrane further comprises a colophone membrane.

16. The method of claim 11, wherein the membrane tank includes a hydraulic cylinder pipe.

17. The method of claim 16, wherein the hydraulic cylinder pipe performs backwashing of the membranes.

18. The method of claim 11, wherein flocculation is performed without adding a flocculating aid and without adding a coagulating aid.

19. The method of claim 11, wherein the effluent from the purification tank is recycled to the pulp and paper making process and reused.

20. The method of claim 11, wherein the coagulants do not include any of ferric chloride, sodium aluminate, aluminum sulfate and aluminum chloride.
